(19) United States
(12) Patent Application Publication
(10) Pub. No.: US 2009/0268983 A1
(43) Pub. Date: Oct. 29, 2009

(54) Digital imaging system and method using multiple digital image sensors to produce large high-resolution gapless mosaic images

(75) Inventors: Gary F. Stone, Livermore, CA (US); David A. Bloom, Livermore, CA (US)

Correspondence Address: James S. Tak;Assistant Laboratory Counsel, Lawrence Livermore National Laboratory, P.O. Box 808, L-703, Livermore, CA, 94551, US

(73) Assignee: The Regents of the University of California

(21) Appl. No.: 11/493,761

(22) Filed: Jul. 25, 2006

Related U.S. Application Data
(60) Provisional application No. 60/702,567, filed on Jul. 25, 2005.
(60) Provisional application No. 60/722,379, filed on Sep. 29, 2005.

(51) Int. Cl. G06K 9/36; H04N 5/225

(52) U.S. Cl. 382/284; 348/218.1; 348/E05.024; 348/335; 348/262

(57) ABSTRACT

A digital imaging system and method using multiple cameras arranged and aligned to create a much larger virtual image sensor array. Each camera has a lens with an optical axis aligned parallel to the optical axes of the other camera lenses, and a digital image sensor array with one or more non-contiguous pixelated sensors. The non-contiguous sensor arrays are spatially arranged relative to their respective optical axes so that each sensor images a portion of a target region that is substantially different from other portions of the target region imaged by other sensors, and preferably overlaps adjacent portions imaged by the other sensors. In this manner, the portions imaged by one set of sensors completely fill the image gaps found between other portions imaged by other sets of sensors, so that a seamless mosaic image of the target region may be produced.

### CLAIM OF PRIORITY IN PROVISIONAL APPLICATION

This application claims the benefit of U.S. provisional application No. 60/702,567 filed Jul. 25, 2005, entitled, “A Method of Optically Stitching Multiple Focal Plane Array Sensors to Produce a Larger Effective Sensor with Zero Gaps in the Image Data” and U.S. provisional application No. 60/722,379 filed Sep. 29, 2005, entitled, “A Method of Optically Stitching Multiple Focal Plane Array Sensors to Produce a Larger Effective Sensor with Zero Gaps in the Image Data” both by Gary F. Stone et al.

The United States Government has rights in this invention pursuant to Contract No. W-7405-ENG48 between the United States Department of Energy and the University of California for the operation of Lawrence Livermore National Laboratory.

### FIELD OF THE INVENTION

The present invention relates to digital imaging systems, and in particular to a digital imaging system and method using multiple digital image sensors together as a larger effective sensor to produce image data capable of being gaplessly combined into a large high-resolution mosaic image.

### BACKGROUND OF THE INVENTION

Various imaging applications, such as for example aerial photography, cartography, photogrammetry, remote sensing/tracking/surveillance, etc., involve high-resolution imaging of large areas. For example, applications which involve surveillance of large areas (e.g. 30 km×30 km area) often require meter scale resolution (e.g. 1 meter GSD) to image and track cars, trucks, buses, etc. For such large area imaging applications, there is a need for a large pixel-count imaging system that is capable of capturing high-resolution large pixel-count images, where “large pixel-count” is typically considered in the gigapixel range. However, since such large pixel-count sensors are not currently commercially available i.e. the current state of the art in pixilated sensors is much less than the imaging requirement for such large area imaging applications, alternative imaging systems and methods of producing such large pixel-count images are required.

Various types of large pixel-count imaging systems have been proposed in the past. One technique uses custom built low yield large pixel-count focal plane arrays (FPAs) which due to their custom fabrication are often prohibitively expensive. Another technique uses low yield, end or edge “buttable” FPAs which may be abutted together to form and effectively larger image sensor. While also being costly, however, these types of buttable FPAs are often problematic with respect to their imaging performance caused by gaps in the image where image data is lost. As such, these known limitations have generally inhibited widespread adoption and use for large area imaging applications.

Another known type of large area imaging system has used multiple arrays of single image collection optics that project an image on a single pixelated sensor. These systems, however, are often not pointed in the same direction. As such, this non-parallel arrangement is known to generate pixels that represent different shaped pixels on the image plane, especially at the edges of the single imaging system fields of view.

What is needed therefore is a large pixel-count digital image forming system and method for imaging large areas at high resolution, that preferably has a total pixel count in the gigapixel range using relatively inexpensive commercial off-the-shelf (COTS) components. Additionally, it would be advantageous to be able to custom configure such a large pixel-count digital image forming system to conform to the shape and scale of a target region, as well as employ particular types/sizes of image sensors as required by the particular imaging application.

### SUMMARY OF THE INVENTION

One aspect of the present invention includes a digital imaging system comprising: at least two optic modules having respective optical axes parallel to and offset from each other; and for each of said optic modules respectively a corresponding set of at least one digital image sensor(s), each sensor spatially arranged relative to the optical axis of the corresponding optic module to image a portion of a target region that is substantially different from other portions of the target region imaged by the other sensor(s) of the system, so that all of said imaged portions together produce a seamless mosaic image of the target region.

Another aspect of the present invention includes a digital imaging system comprising: at least four coplanar optic modules having respective optical axes parallel to and offset from each other; and for each of said optic modules respectively a corresponding set of at least four rectangular pixellated image sensors selected from a group consisting of visible, IR, UV, microwave, x-ray, photon, image intensified night vision, and radar imaging digital image sensors and arranged in a matrixed array having at least two rows and at least two columns, each sensor non-contiguously arranged relative to the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together produce a seamless mosaic image of the target region.

Another aspect of the present invention includes a digital imaging system comprising: at least two cameras, each camera comprising: a lens having an optical axis parallel to and offset from the optical axes of the other camera lens(es) so that an image circle thereof does not overlap with other image circle(s) of the other camera(s); and a digital image sensor array having at least two digital image sensors each non-contiguously arranged relative to each other to digitally capture a portion of a target region which is substantially different from other portions of the target region digitally captured by the other sensors in the system but which partially overlaps with adjacent portions of the target region so that all of said portions together optically produce a gapless mosaic image of said target region.

Another aspect of the present invention includes a multi-camera alignment method for producing gapless mosaiced images comprising: aligning at least two optic modules coplanar to and laterally offset from each other so that respective optical axes thereof are parallel to each other; and for each of said optic modules respectively, spatially arranging on a common focal plane a corresponding set of at least one pixelated digital image sensor(s) relative to the optical axis of the corresponding optic module to image a portion of a target region that is substantially different from other portions of the target region imaged by the other sensor(s) of the system so that all of said portions together produce a seamless mosaic image of the target region.

Another aspect of the present invention includes a multi-camera alignment method for producing gapless mosaiced images comprising: aligning at least four optic modules coplanar to and laterally offset from each other so that respective optical axes thereof are parallel to each other; and for each of said optic modules respectively, spatially arranging a corresponding set of at least four rectangular pixellated image sensors selected from a group consisting of visible, IR, UV, microwave, x-ray, photon, image intensified night vision, and radar imaging digital image sensors in a matrixed array having at least two rows and at least two columns, so that each sensor is spaced from the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together produce a seamless mosaic image of the target region.

Another aspect of the present invention includes a digital imaging method comprising: providing at least two optic modules having respective optical axes parallel to and offset from each other; and for each of said optic modules respectively a corresponding set of at least one digital image sensor(s), each sensor spatially arranged relative to the optical axis of the corresponding optic module to image a portion of a target region that is substantially different from other portions of the target region imaged by the other sensor(s) of the system so that all of the portions together image all of the target region without gaps therein; shuttering the at least two optic modules to digitally capture image data of all the portions of the target region on said sensors; and processing the digitally captured image data to mosaic all the imaged portions of the target region into a seamless mosaic image thereof.

Another aspect of the present invention includes a digital imaging method comprising: providing at least four coplanar optic modules having respective optical axes parallel to and offset from each other, and for each of said optic modules respectively a corresponding set of at least four rectangular pixellated image sensors selected from the group consisting of visible, IR, UV, microwave, x-ray, photon, image intensified night vision, and radar imaging digital image sensors and arranged in a matrixed array having at least two rows and at least two columns, each sensor non-contiguously arranged relative to the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together image all of the target region without gaps; simultaneously shuttering the at least four coplanar optic modules to digitally capture image data of all the portions of the target region on said sensors; and processing the digitally captured image data to mosaic all the imaged portions of the target region into a seamless mosaic image thereof.

Generally, the present invention is a digital imaging system and method which uses multiple sets of pixellated digital image sensors (such as for example focal plane array (FPA) sensors) to individually image portions of a target region and gaplessly join the multiple imaged portions into a composite mosaic image. In effect, the system provides a method of generating larger pixel-count images for a larger field of view with the potential to provide higher resolution or a larger area of coverage than current single sensor or end butted focal plane array sensors currently in use. As such the multiple sets of sensors are used as an effectively larger-overall “virtual” image sensor array (i.e. having higher total pixel count) without moving parts. Moreover, the present invention enables the use of an arbitrary number of smaller commercially available pixelated sensors together to generate the seamless large pixel-count image. This imaging optic and pixelated sensor arrangement generates a continuous and seamless image field, where the stitch lines are parallel and have the nearly same angular field of view of the image plane. There are no discontinuities or breaks in the image field at the edges of each sensor. This invention can produce an arbitrarily large image without any seams or gaps in covers on the image plane. The image perspective in adjacent image fields is smoothly varying and does not contain changes in point of view from adjacent image sensor fields. With this large pixel count image collection and stitching method, it is possible to produce an image forming system without any gaps in image coverage, major discontinuities at the image stitch boundaries or any major distortion in the images at those image stitch boundaries. This will generate an image data set that effectively looks like it was generated by a very large pixel count monolith sensor instead of a number of individual sensors arranged behind multiple sets of image forming optical elements. This method allow the recording of single images of objects at a higher pixel count than currently available without the need to move the object and record multiple images. This is essential for “snapshots” of objects that are large and not easily moved, such as in imaging Earth during aerial photography or remote sensing applications. When the ground resolution requirement exceeds current single sensor capabilities, this method would allow higher spatial resolution or when used in multiple sets of arrays for multi-spectral band imaging applications. With the addition of using multiple image sensors with a single imaging optic will enable enough focal plane sensors to be optically joined together to image the gigapixel class image without any gaps in the data. (high pixel count imaging systems). This technique enables the use of existing electronic image sensors and lenses and link them together to form what is in effect a single image sensor capable of imaging, for example, a 31.6 km×31.6 km area at 1 meter per pixel ground sampling.

In particular, the technique uses a set of focal plane arrays and lenses, arranged in such a manner to produce an image that is equivalent in picture elements (pixel) count to the sum of the arrays optically joined, minus a small amount for overlap between adjacent focal plane arrays. Moreover, the contiguous or overlapping image data captured by the set of independent digital image sensors according to the present invention can be joined without complex computer processing. In particular, multiple sets of focal plane array (FPA) sensors are aligned and arranged relative to an optical axis of a corresponding optic module to simultaneously digitally capture image data which is substantially different from image data captured by other FPA sensors, so that all the image data may be seamlessly mosaiced together into a gapless mosaic image. In this sense, the present invention enables the image outputs simultaneously produced by each sensor to be “optically stitched” together into a single seamless contiguous image, which obviates the need to move the object or to record multiple images at different times. In particular, the method describes how to take a set of existing electronic imaging sensors of a finite size and optically combine them to generate much larger effective sensor array (in total pixel count) than is currently available. It uses a set of focal plane arrays and lenses, arranged in such a manner to produce an image that is equivalent in picture elements (pixel) count to the sum of the arrays optically joined, minus a small amount for overlap between adjacent focal plane arrays. It is possible to use this arrangement of lenses and FPA sensors with nearly any currently manufactured electronic FPA of any size and pixel count or for as yet to designed and built sensor arrays in the future.

This technique relies upon the image producing element (i.e. optic module or lens) be capable of generating an image circle or image plane that is larger than the detector package. In particular, it divides the image plane up into sectors that are offset in adjacent imager fields. The offsets and displacements in the 4 adjacent image fields allows for a contiguous coverage of the area being observed and recorded. In the simplest manifestation, a circular image field, the image formed by an optical lens used for a conventional camera is usually a circle that is 125% or larger than the usual detector it was designed to be used with. If the image circle is >4× larger than the sensor package, the image circle can be divided up into segments and recorded on the four separate detectors. If the alignment and calibration of the sensor images is done with care, the four images can be stitched together to form a single image for analysis, viewing and/or transmission. If the image circle is >>4× the detector/sensor element, an image with an arbitrarily large number of pixels cam be produced for a given object field. The limitation is in the packaging of the sensor elements and the ability to produce a lens (in the case of optical imaging schemes) that produces and projects an image circle of sufficient size.

The sensors and spacing behind the four lenses, if extended to other “Imaging” methodologies can lead to a method of allowing much higher spatial resolution and pixel count images to be produced than the current sensor technology can support. As digital camera sensors increase in pixel count, there is a fundamental limit in how small the size of the individual pixels can be produced. As the pixels become smaller, it placed a much higher requirement on the optical design and fabrication of the lens. In addition, there is price in intensity dynamic range that comes into play when the pixels become smaller. A result of the fabrication steps for a CCD or CMOS sensor is that the dynamic range or ability to see bright to dark image points and faithfully record them is compromised. If the depletion depth of the electron traps within a pixel are set to the maximum for a particular process, it can only record a limited amount of image intensity data or dynamic range. As the pixel size is reduced, the dynamic range is reduced. This limitation, coupled with the higher requirements for the lenses is what drives this technique to being adopted for a variety of sensor/imaging applications.

One particular limitation for this application is that parallax becomes a problem when imaging objects close to the camera system. As the lenses will be a finite distance apart, the image fields for these sensors will point to different locations in the object. As such the present application is preferably used for applications where the object plane is far from the sensor field, the difference in the pointing in the four separate cameras is less than the foot print of a pixel on the object.

The system and method of the present invention uses at least two image forming optical systems, i.e. cameras, with parallel optical axes and corresponding sets of pixelated sensors in a specific pattern and spatial arrangement behind those image forming optics. The arrangement and placement of the sensors in one field will have gaps that are covered by the arrangement and placement of the sensors in an adjacent image field. The alignment in the horizontal and vertical axes of all the sensors must be precise to within less than one pixel element over all sensors. Likewise the alignment of the rows and columns of all the sensors must be less than one pixel width with respect to all other sensors in the composite, mosaic imaging system.

An array of pixellated sensors are arranged at the focal plane of each lens such that the edges of field of view from one sensor overlaps spatially the position of the sensor in an adjacent frame, relative to the optical axis of the lens. The X,Y spatial position of the sensors are arranges such that the gaps in one lens/sensor set are imaged by those in an adjacent lens/sensor pair. Another requirement of the system is the ability to place the sensors laterally such that the spacing between sensors in single image forming optical arrangement is less than a single pixel with respect to adjacent sensor in that imaging chain and the other sensors in adjacent image forming chains. The image field presented in one image field will be nearly identical to that of the adjacent image forming field. The point of view difference will be the difference in lateral spacing of the image forming optics of the adjacent image chains. For imaging systems used at working distances of <100 times that focal length of the imaging optic, the images of the single optics will be offset laterally at the image plane. When those are on the order of ¼ of the spatial size of the individual pixels on the image plane, there will be some parallax in the image point of view between adjacent image chains. However, when the image field is very far from the optical system, the view from a sensor in one image chain is essentially identical to the view in an adjacent image chain. This imaging system has the greatest applicability in long standoff imaging systems such as aerial photography, cartography, photogrammetry or remote sensing systems.

The alignment of the sensors is important in that the boundary of one row or column of pixels as seen in one lens/sensor set, relative to the optical axis of the lens overlays with the overlap region coverage in an adjacent lens/sensor set. It is the checkerboard arrangement of the sensors, with the proper overlap and alignment, that allows an arbitrarily large effective imaging system to be generated.

By preferably using a set of four lenses, an arrangement of identical sensors can be tiled together to produce a larger effective sensor, when the images are stitched together. Thus a preferred embodiment uses 4 imaging optics to record a scene at some distance from the camera system. The 4 lenses are pointed parallel to each other. The lenses are offset laterally such that the image circles form each lens do not cause an image from one lens to overlap any of the other lenses. Preferably, 4 separate image forming optical systems and 4 separate pixelated image planes are used to record a seamless image that when presented on a display system or reproduced in hardcopy form appears to be from a monolithic pixelated sensor and imaging system. The arrangement of the sensors at the focal plane of the image forming optical system is the key to this new and novel large pixel count image forming system.

Various sensor types may be used such as IR, visible, UV, microwave, x-ray, photon, image intensified night vision sensors, radar imaging sensors, or any other electromagnetic radiation imaging sensor type. Commercially available digital image sensors may be used (COTS) This technology is useful wherever there exists a need for an image sensor that is larger in pixel count than anything commercially available. This technology is beneficial in reducing the cost per pixel by using readily available, relatively low-cost large-area image arrays to replace limited production, high-cost per pixel very large image arrays.

The sensors are not limited to the rectangular shapes, i.e. shapes having four 90 degree angles. Square, rectangular, triangular, hexagonal or any other shape may be used for the sensors of this invention. The important point is that the use of multiple lenses/optic modules that allow for all of the edges of a single pixellated sensor to be recorded, with no gaps in the image data being collected.

The Scheimpflug technique suggests the need for the sensors to occupy a parallel plane behind the four independent lenses. This allows the overlapping image fields of the separate sensors, behind their separate lenses, to act in unison as a single, much larger monolithic sensor. By placing the sensors, relative to the optical axis of the lenses, at offsets that are unit pixel multiples, a contiguous image field can be collected in this manner.

Another advantage of the invention is the ability to produce larger images with existing COTS sensors. Large monolithic sensors are expensive, difficult to produce and very difficult to readout in a reasonable time frame—shorter than the inner frame time needed by the sensor system. An array of smaller sensors, with smaller pixel counts can be connected to an image collection system made up of many smaller, less expensive processors. The time needed to “clock” out or read an entire image from a gigapixel camera, using a monolithic sensor, would be much longer than the time to read out the 96 smaller sensors as shown in my plots.

Customizable sensor configuration for imaging odd-shaped target regions—It is also applicable to produce images of arbitrary size, aspect ratio and pixel count in the horizontal and vertical axes of the composite image. This can produce a sensor that can have non-rectangular shapes as well. If a cross roads or intersection were needed to be recorded at high spatial resolution, an arrangement of sensors in a “T” shape could be formed behind the lens/sensor sets and only record those areas of interest. This can be done with current larger sensors by throwing away the wanted data, but for some sensor types you still need to readout the entire array before you parse out the required pixels. For even odder shaped applications, such as the inspection of industrial process at high resolution, an arrangement of sensors could be envisioned that could just look at the center and corners and other selected regions of the image field at one time. Again it is the ability to optically multiplex many smaller sensors together to form a higher pixel count final “image” than is currently available.

The digital imaging system and method of the present invention is not limited to visible light imaging system applications, but also can be applied to infrared, ultraviolet, microwave or x-ray imaging regimes. Any imaging or sensor application where the pixel count needed exceeds those of a single sensor can employ this technology. Thus while this method of optically stitching images together is primarily designed for aerial remote sensing from high altitude air transport platforms, but could be used for other imaging modalities such as astronomy, x-ray radiography, transmission electron microscopy, x-ray imaging for computer-assisted tomography or other areas where the current pixel count of available sensors is inadequate to meet the requirements of the project. This method could be used for aerial surveillance for Homeland Defense, national Defense and Department of Defense applications. It also has utility in the collection of images from high altitude balloon-based sensors for weather, navigation, pollution sensing or military and geopolitical applications. And other applications may include the recording of high pixel count, high spatial resolution, images of flat or 3 dimensional works of art, historical documents or equipment or imagery used for remote sensing of agriculture, urban planning or GIS/mapping applications. Generally, the technique has application in a number of other areas where an “Image” or “Image-like” representation of scene or depiction of a spatially varying 2D output from a variety of detectors. While the present invention may be ideally used in aerial photographic applications it may be used in any application where the number of pixels desired from the area or region of interest exceed current detector technology pixel count. The method of multiplexing detectors in a checkerboard array, with 4 lenses is used to allow a contiguous coverage on the object plane to be mapped onto multiple detectors in the image plane. The apparatus and method of the present invention can be applied to more than just aerial photographic applications. For example, it is also applicable to other areas of “Imaging” such as IR, UV, microwave, radar, thermal, ultrasonic and x-ray imaging systems. And the present invention is preferably used for such imaging applications as aerial photography, cartography, photogrammetry, remote sensing are potential uses for this system.

### BRIEF DESCRIPTION OF THE DRAWINGS

The accompanying drawings, which are incorporated into and form a part of the disclosure, are as follows:

FIG. 1 is a perspective view of a first exemplary embodiment of the present invention having four cameras each with an optic module and a set of four rectangular digital image sensors arranged in a 2×2 matrixed array.

FIG. 2 is a side view taken along line 2-2 of FIG. 1.

FIG. 3 is an axial view along the optical axis O₁₁ of the positions of the rectangular sensors of set A in FIG. 1 relative to the optical axis O₁₁ and the image circle 30.

FIG. 4 is an axial view along the optical axis O₁₂ of the positions of the rectangular sensors of set B in FIG. 1 relative to the optical axis O₁₂ and the image circle 40.

FIG. 5 is an axial view along the optical axis O₁₃ of the positions of the rectangular sensors of set C in FIG. 1 relative to the optical axis O₁₃ and the image circle 50.

FIG. 6 is an axial view along the optical axis O₁₄ of the positions of the rectangular sensors of set D in FIG. 1 relative to the optical axis O₁₄ and the image circle 60.

FIG. 7 is an enlarged view of circle 7 in FIG. 3.

FIG. 8 is an enlarged view of circle 8 in FIG. 4.

FIG. 9 is an enlarged view of circle 9 in FIG. 5.

FIG. 10 is an enlarged view of circle 10 in FIG. 6.

FIG. 11 is an axial view along a virtual optical axis Oᵥ of a gapless mosaiced image produced from all portions of a target region respectively imaged by the sensor sets A-D of FIG. 1 shown relative to the virtual optical axis Oᵥ and a virtual image circle.

FIG. 12 is an enlarged view of circle 12 of FIG. 11 illustrating the overlapping regions of the imaged portions.

FIG. 13 is an axial view along a virtual optical axis Oᵥ of a gapless mosaiced image produced from two portions of a target region respectively imaged by a second illustrative embodiment having two sensor sets each comprising a single sensor.

FIG. 14 is an axial view along a virtual optical axis Oᵥ of a gapless mosaiced image produced from four portions of a target region respectively imaged by a third illustrative embodiment having four sensor sets each comprising a single sensor.

FIG. 15 is an axial view along a virtual optical axis Oᵥ of a gapless mosaiced image produced from 96 portions of a target region respectively imaged by a fourth illustrative embodiment having four sensor sets each comprising 24 non-contiguous sensors arranged in a 6×4 matrixed array.

FIG. 16 is an axial view along a virtual optical axis Oᵥ of a gapless mosaiced image produced from 48 portions of a target region respectively imaged by a fifth illustrative embodiment having four sensor sets each comprising 12 non-contiguous sensors arranged in a 2×6 matrixed array.

FIG. 17 is an axial view along a virtual optical axis Oᵥ of a gapless mosaiced image produced from four portions of a target region respectively imaged by a sixth illustrative embodiment having four sensor sets each comprising a single triangular sensor.

FIG. 18 is an axial view along a virtual optical axis Oᵥ of a gapless mosaiced image produced from 22 portions of a target region respectively imaged by a seventh illustrative embodiment having eight sensor sets, seven of which respectively comprise three non-contiguous triangular sensors and one of which comprises a single triangular sensor.

FIG. 19 is an axial view along a virtual optical axis Oᵥ of a gapless mosaiced image produced from six portions of a target region respectively imaged by a eighth illustrative embodiment having six sensor sets each comprising a single triangular sensor.

FIG. 20 is an axial view along a virtual optical axis Oᵥ of a gapless mosaiced image produced from 24 portions of a target region respectively imaged by a ninth illustrative embodiment having eight sensor sets each comprising three non-contiguous triangular sensors.

FIG. 21 is an axial view along a virtual optical axis Oᵥ of a gapless mosaiced image produced from three portions of a target region respectively imaged by a tenth illustrative embodiment having three sensor sets each comprising a single hexagonal sensor.

FIG. 22 is an axial view along a virtual optical axis Oᵥ of a gapless mosaiced image produced from 12 portions of a target region respectively imaged by an eleventh illustrative embodiment having three sensor sets each comprising four non-contiguous hexagonal sensors.

### DETAILED DESCRIPTION

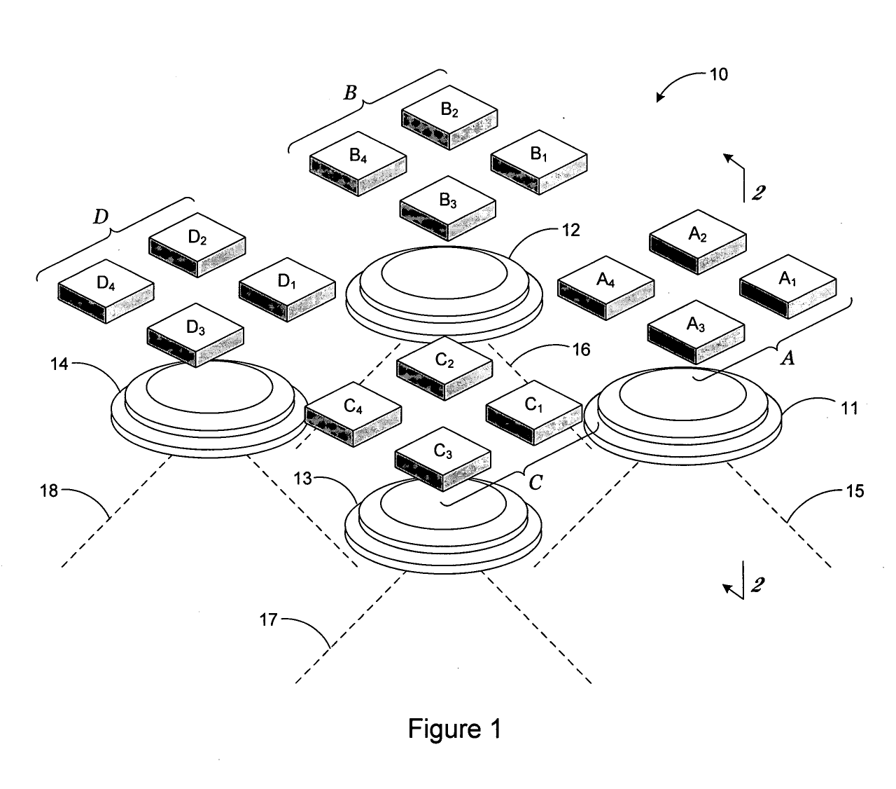

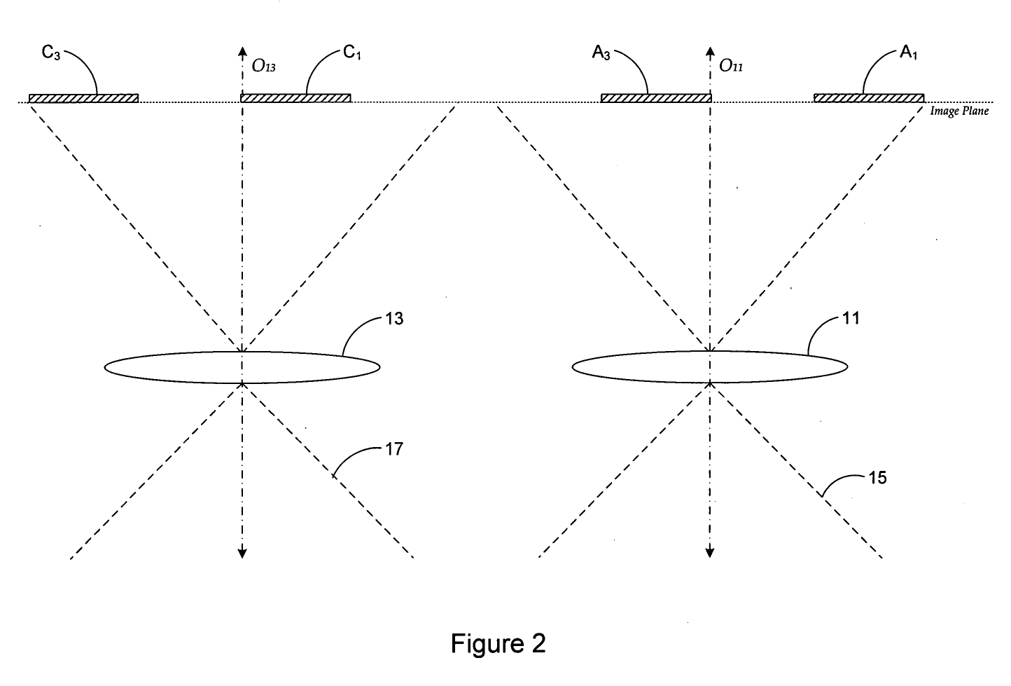

Turning now to the drawings, FIGS. 1-12 show a first exemplary embodiment of the digital imaging system of the present invention, generally indicated at reference character 10 in FIG. 1. In particular FIG. 1 shows a perspective view of the system 10 having four optic modules 11-14 and a corresponding set of digital image sensors which can be, for example, pixelated focal plane array sensors or pixelated CCDs. In particular, optic module 11 is shown having a field of view 15 for focusing scenes onto sensor set A comprising four sensors A1-A4 along its optical axis (see O11 in FIG. 2); optic module 12 is shown having a field of view 16 for focusing scenes onto sensor set B comprising four sensors B1-B4 along its optical axis (not shown); optic module 13 is shown having a field of view 17 for focusing scenes onto sensor set C comprising four sensors C1-C4 along its optical axis (see O13 in FIG. 2); and optic module 14 is shown having a field of view 18 for focusing scenes onto sensor set D comprising four sensors D1-D4 along its optical axis (not shown). Each sensor images only a portion of the target region because the “field of view” associated with each sensor is different from all other sensors. The target region is preferably a distal target region (e.g. for aerial photography).

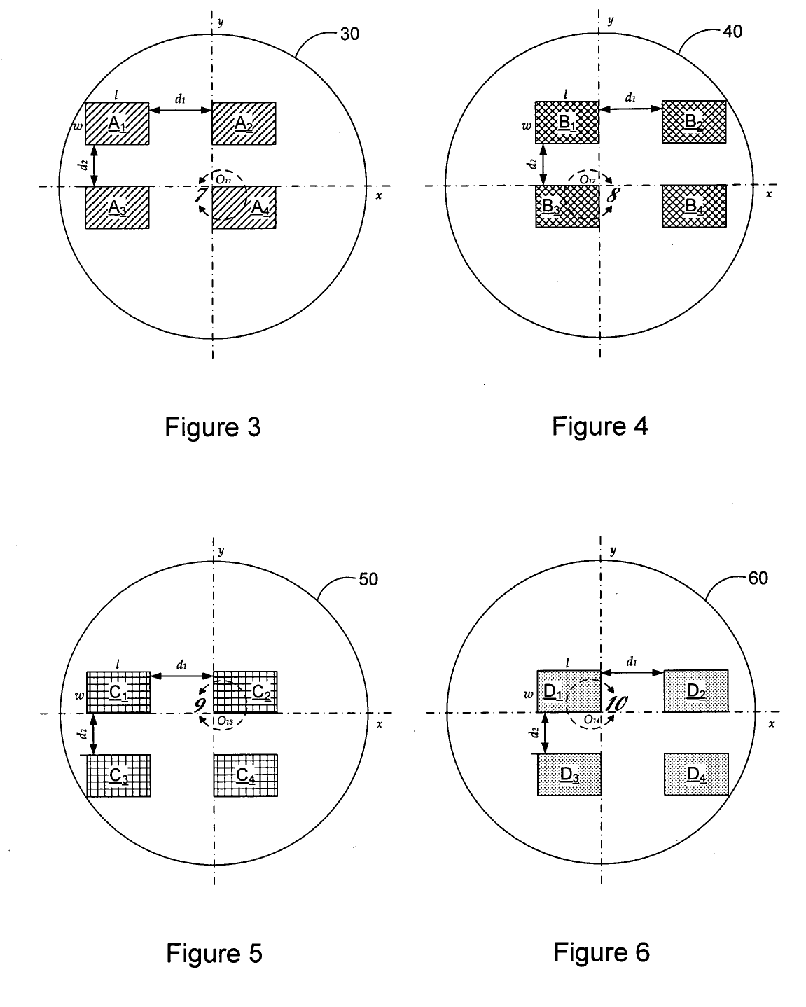

Each optic module/sensor set pairing may be characterized as an independent camera capable of focusing a scene onto an image plane (e.g. focal plane) to be digitally captured by a corresponding sensor set. The optic modules 11-14 are shown offset and spaced from each other so that the respective image circles (see 30, 40, 50, and 60 in FIGS. 3-6) as well as the sensor sets located within the image circles, do not overlap. In particular, as shown in FIG. 2, the respective optical axes of the optic modules are parallel to and offset from each other a sufficient distance to prevent overlapping of the image circles and sensor sets. FIG. 2 shows a side view taken along line 2-2 of FIG. 1, illustrating the spatial arrangement of two representative sensor sets A and C relative to optical axes O11 and O13, respectively, of the associated optic modules 11 and 13, respectively. As shown in FIG. 2, sensor set A is represented by sensors A1 and A3, and sensor set C is represented by sensors C1 and C3, with all the sensors aligned coplanar to each other on a common image plane. Additionally, sensor set C is shown offset left of center and sensor set A is shown offset right of center. And each optic module preferably comprises at least one optic element, e.g. lens, prism, mirror, etc. known in the optical arts.

FIGS. 3-6 illustrate the spatial arrangement of each of the sensor sets A-D, respectively, relative to the optical axis of the corresponding optic module. In particular, FIG. 3 shows four sensors A1-A4 aligned and arranged in a matrixed array having two rows and two columns. The four sensors are shown having a rectangular shape with identical dimensions, i.e. length l and width w. The first and second rows are shown spaced/offset from each other by a distance d2, and the first and second columns are shown spaced/offset from each other by a distance d1. Similarly, FIGS. 4-6 also show sensor sets B-D, respectively, also aligned and arranged in matrixed arrays having two rows and two columns, with each sensor having a rectangular shape, identically dimensioned with a length l and width w, and identically spaced/offset by distance d1 between columns and by distance d2 between rows. Additionally, each of the sensor sets are shown positioned within a corresponding image circle, i.e. 30 in FIG. 3, 40 in FIG. 4, 50 in FIGS. 5 and 60 in FIG. 6.

Also shown in FIGS. 3-6 is the spatial arrangement of the sensor sets in the respective image circles. As shown the sensors are all located within their respective image circles, and their spatial arrangement is relative to a reference coordinate system common to all of the lens (with the reference coordinate system having the optical axis of the lens at the origin) and so that the overlay of the sensor arrays about the common optical axis in the reference coordinate system completely fills (mutually) the spatial gaps in the other sensor arrays. In this manner, the multiple lenses of the system produce a virtual image circle 110 with a virtual common optical axis Ov to completely fill spatial gaps in the other sensor arrays, whereby image data captured from each of the cameras are optically stitchable with image data from the other cameras to produce a large seamless image. In this manner, the sensor arrays are spatially arranged relative to their respective optical axes to mutually fill each other's spatial gaps when overlaid to share a common optical axis. In this manner, a full image may be formed from the optical combination of the outputs image portions so that each sensor array captures a portion of a full image and the portions together seamlessly form the full image in a virtual image circle formed by overlaying the image circles of the cameras along a common optical axis.

While the drawings show all digital image sensors within the image circle, it is appreciated that the additional sensors may be added or larger sensors may be used to completely fill the image circle and thereby capture even more portions of the target area. Of course this would mean that if the same shaped sensors are used, then some pixels of those overextending sensors (being outside the image circle) will not operate to capture data. This can be addressed in the post-processing stage to account for those pixels. In such a case the image produced would have the same contour as the image circle, e.g. circular. Of course post-process cropping is always available as known in the art to edit the image to have desired shape/dimensions.

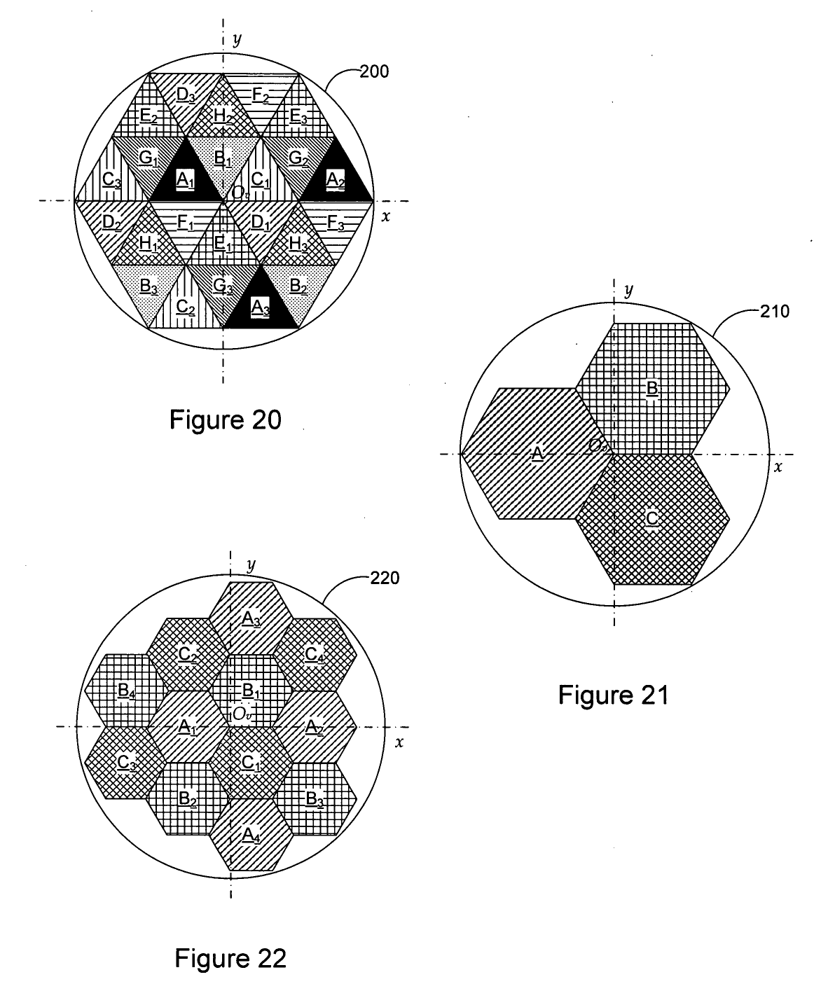

Preferably, as shown in FIGS. 1-12, the each sensor set is spatially arranged into a matrixed array comprising rows and columns. Compare this to triangular array, and generally non-matrixed array shown in FIGS. 20-24 of drawings). Each of said matrixed arrays respectively form at least two rows and at least two columns so that the mosaiced image of the target region is comprised of four-quadrant blocks each quadrant being a sensor from one of the four optic modules.

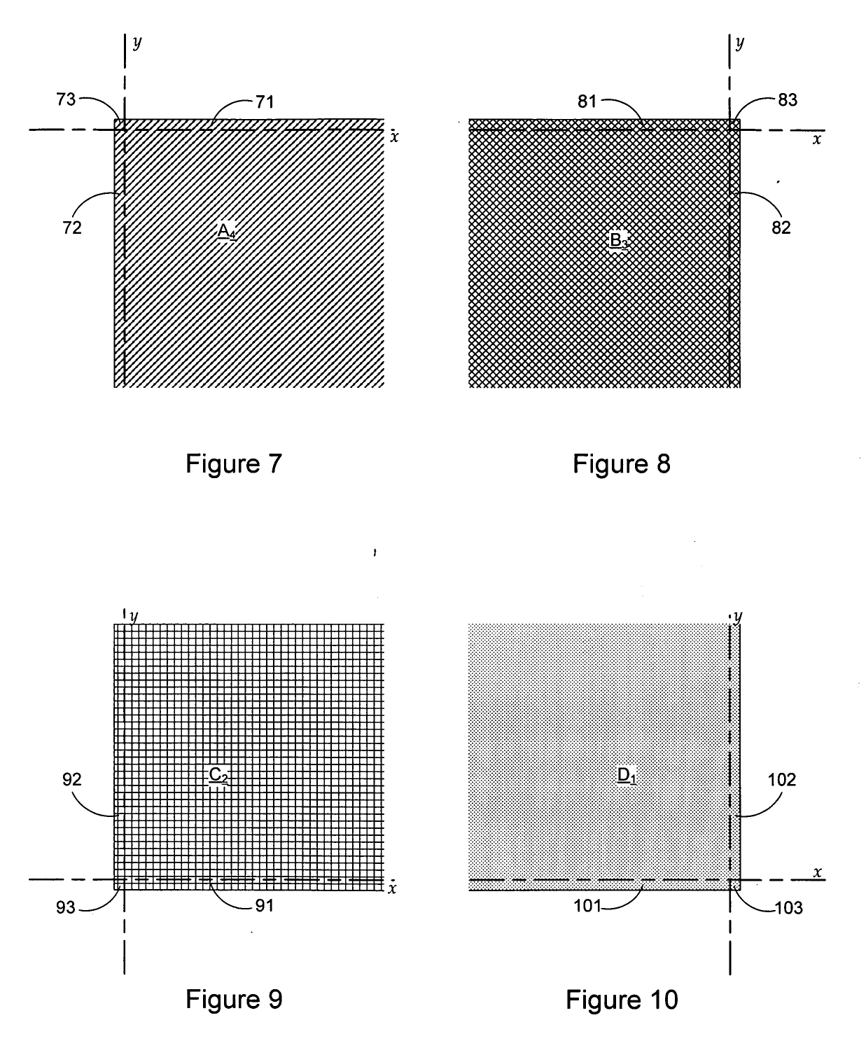

Offsetting arrangement to overlap the imaged portions with adjacent imaged portions—FIGS. 7-10 show how the sensors are offset so that they extend beyond the x and y axes defining the four discrete quadrants. FIG. 7 shows sensor A3 extending just beyond the 3^{rd} quadrant of a coordinate system demarcated by the x and y axes. This produces a region 71 that is in the 2^{nd} quadrant, a region 72 in the 4^{th} quadrant, and a region 73 in the 1^{st} quadrant. Discuss same for each of FIGS. 8-10.

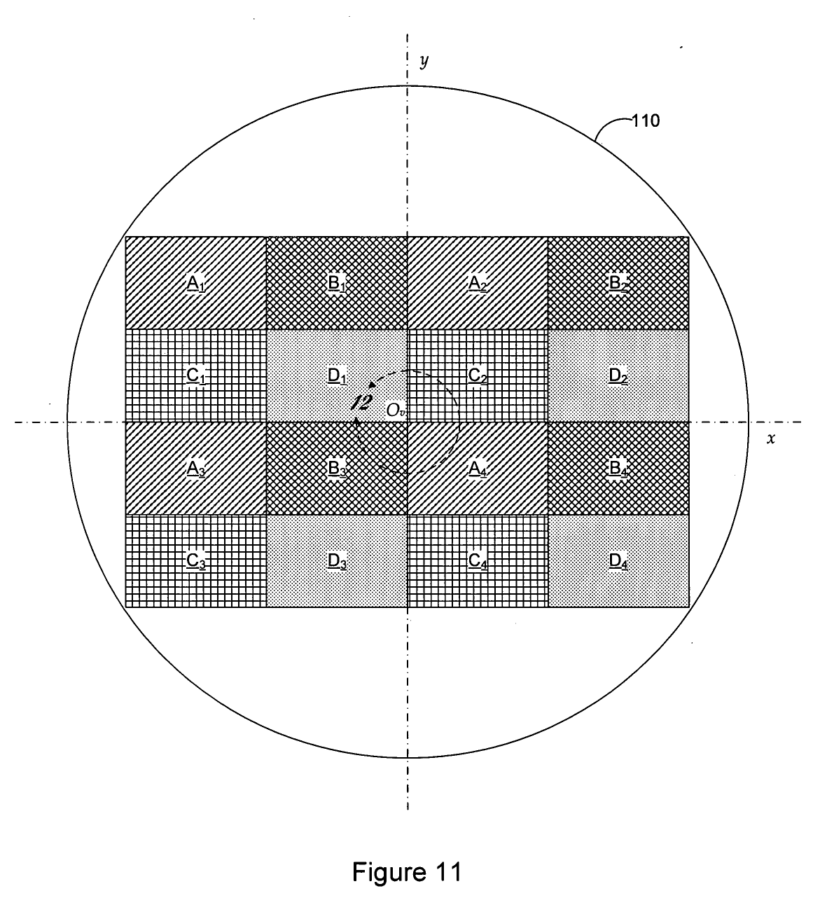

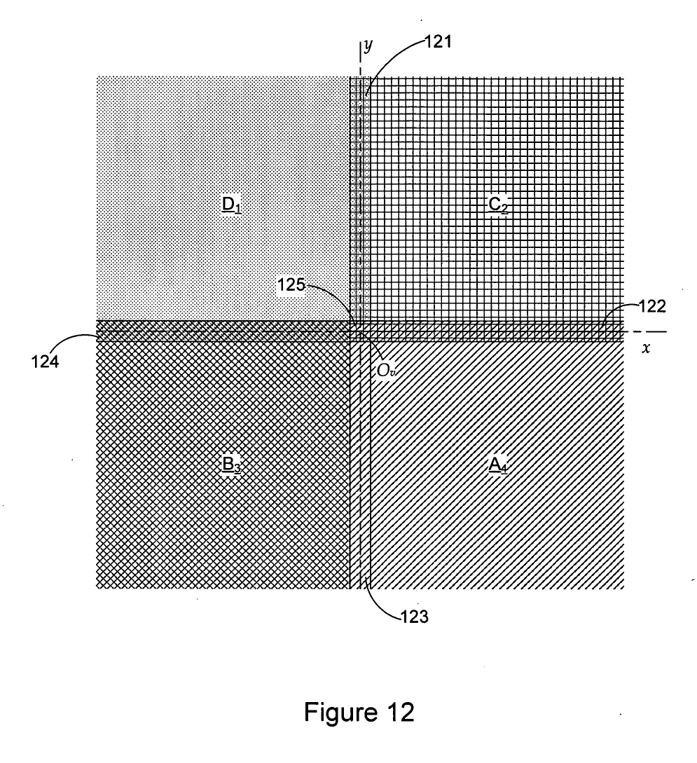

Imaging step of each of the portions of the target region—FIG. 11 shows the effective larger overall image produced by seamlessly mosaicing the portions individually imaged by the sensors. Preferably the imaging of the portions take place simultaneously. When all the sensors are simultaneously imaged, each sensor captures a portion of the target region. Post-processing of image data is then performed in a manner known in the data processing arts to combine, stitch, overlay, or otherwise digitally mosaic all the portions together into a composite mosaic image. The “overlay” image shown in FIG. 11 is a visual representation of the mosaicing step performed during post-processing. FIG. 12 is enlarged view of circle 12 in FIG. 11 showing details of the overlapping sections between adjacent imaged portions corresponding to digital image sensors A4, B3, D1, and C2, each from a different sensor set. As shown overlapping portions 121, 122, 123, and 124 are formed between adjacent imaged portions D1, C2, A4 and B3. Alignment precision is critical to control the degree of overlap. Preferably, overlap is measured by number of pixel rows or columns overlapping. Preferably the minimum overlap is 1 pixel width.

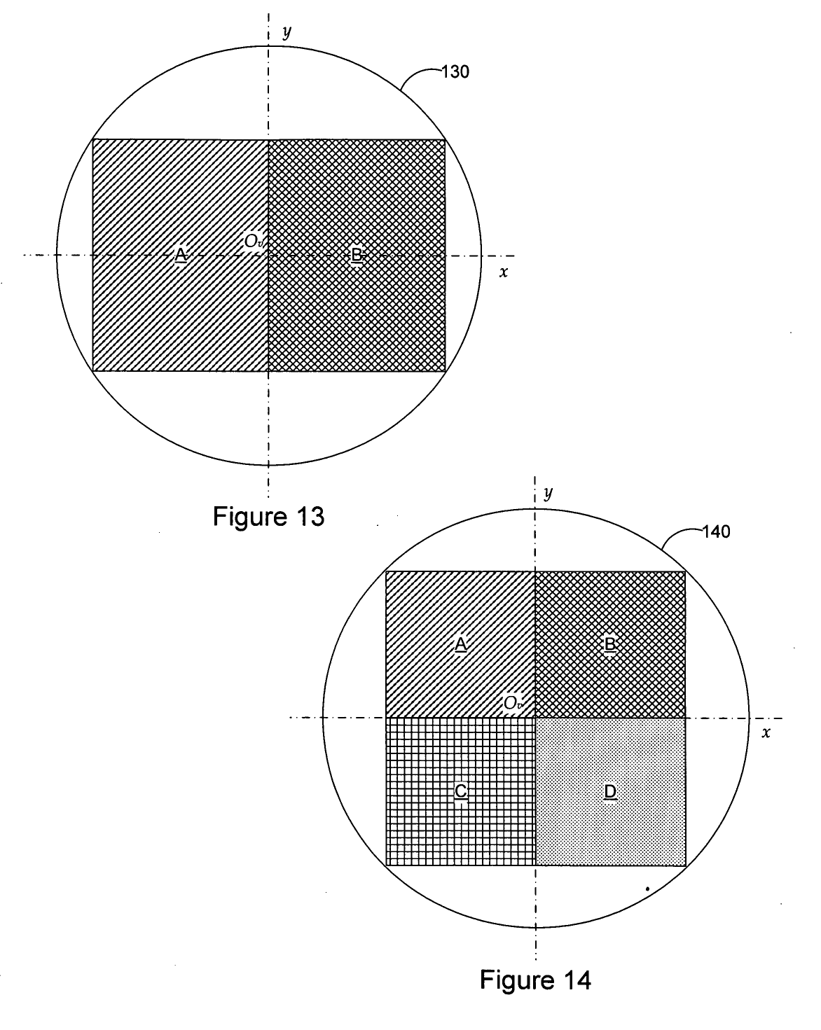

FIG. 13 shows a schematic view of a gapless mosaiced image produced from two portions of a target region respectively imaged by a second illustrative embodiment having two sensor sets (not shown) each comprising a single sensor. This illustrates how a minimum of two cameras may be used in the present invention, and how a minimum of one digital image sensor may be associated with the optic module. FIG. 13 shows a single sensor A of a first optic module/camera (not shown) which is offset positioned relative to an optical axis, and how a single sensor B of a second optic module/camera (not shown) is offset positioned relative to another optic axis, so that when corresponding portions of a target region are imaged and joined in a virtual image circle 130, the two imaged portions together produce a gapless mosaic of the target region. The manner by which a gap is prevented may be either by precisely aligning the positions of each of the sensors A and B so that the imaged portions optically abut against each other perfectly without any overlap, or provide some degree of overlap as discussed above.

FIG. 14 is a schematic view of a gapless mosaiced image produced from four portions of a target region respectively imaged by a third illustrative embodiment having four sensor sets each comprising a single sensor. This figure illustrates that other rectangular shapes (i.e. having four 90 degree angles) may be used, such as the square shape shown. In this case, four optic modules are each respectively associated with a single sensor. In the mosaicing step shown in FIG. 14, the imaged portions A1-D1 all combine to produce the seamless mosaic image in the image circle 140.

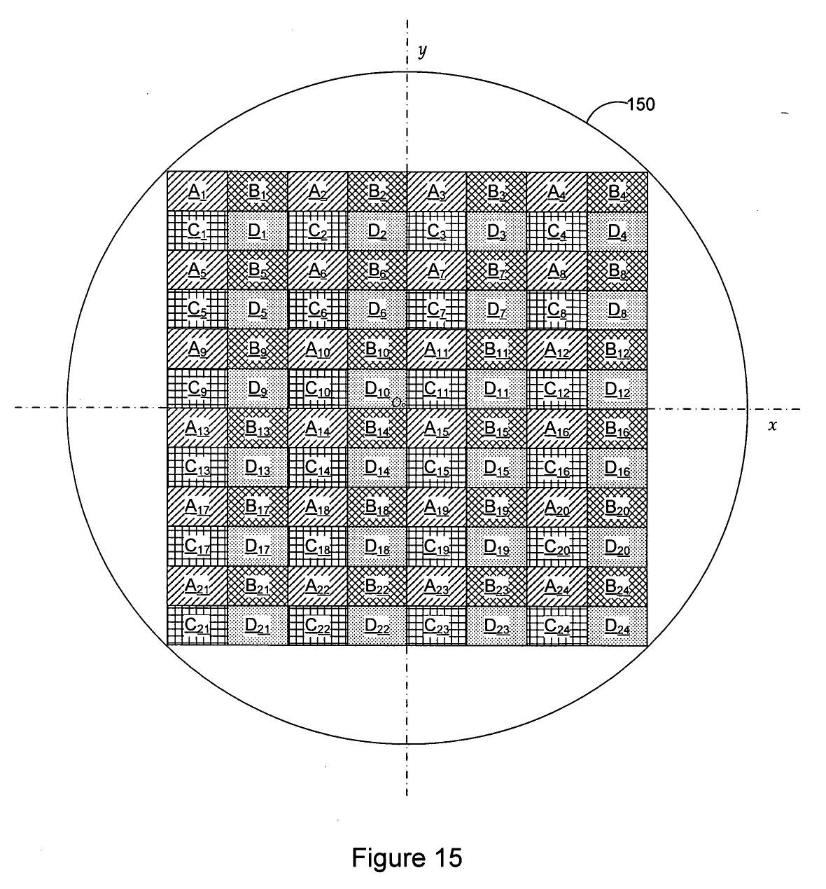

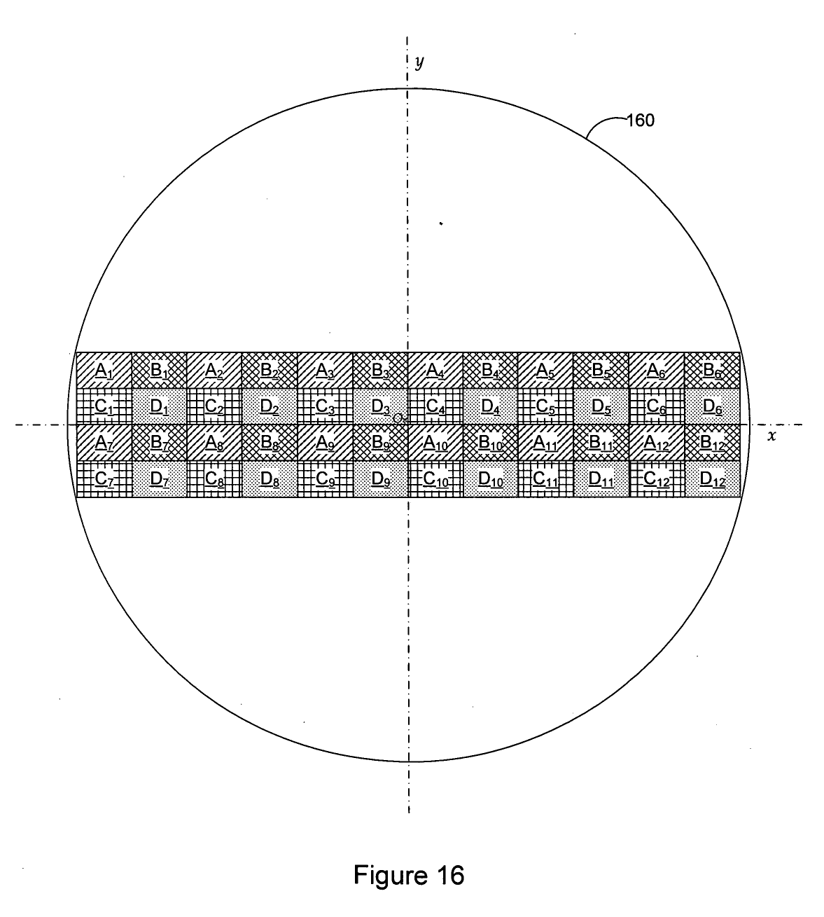

FIG. 15 is a schematic view of a gapless mosaiced image produced from 96 portions of a target region respectively imaged by a fourth illustrative embodiment having four sensor sets each comprising 24 non-contiguous sensors arranged in a 6×4 matrixed array. This Figure illustrates how smaller dimensioned sensors may be employed in a non-contiguous matrixed array. And FIG. 16 is a schematic view of a gapless mosaiced image produced from 48 portions of a target region respectively imaged by a fifth illustrative embodiment having four sensor sets each comprising 12 non-contiguous sensors arranged in a 2×6 matrixed array. As previously discussed this embodiment illustrates how a particularly shaped target region may be imaged, in this case an elongated target region.

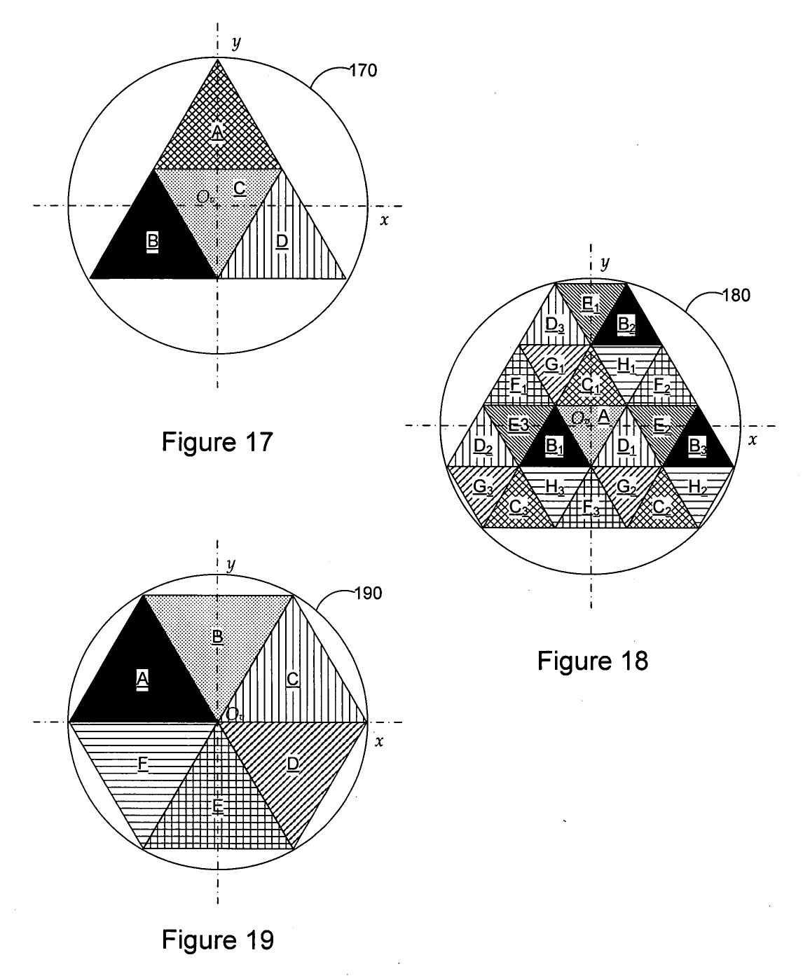

FIGS. 17-20 show axial views of a gapless mosaiced image produced using triangular shaped image sensors. In particular, FIG. 17 shows the mosaiced image produced from four portions of a target region respectively imaged by a sixth illustrative embodiment having four sensor sets each comprising a single triangular sensor. FIG. 18 is a schematic view of a gapless mosaiced image produced from 22 portions of a target region respectively imaged by a seventh illustrative embodiment having eight sensor sets, seven of which respectively comprise three non-contiguous triangular sensors and one of which comprises a single triangular sensor. FIG. 19 is a schematic view of a gapless mosaiced image produced from six portions of a target region respectively imaged by a eighth illustrative embodiment having six sensor sets each comprising a single triangular sensor. And FIG. 20 is a schematic view of a gapless mosaiced image produced from 24 portions of a target region respectively imaged by a ninth illustrative embodiment having eight sensor sets each comprising three non-contiguous triangular sensors.

And FIGS. 21 and 22 show an alternative hexagonal sensor shape used to produce seamless mosaic images. In particular, FIG. 21 is a schematic view of a gapless mosaiced image produced from three portions of a target region respectively imaged by a tenth illustrative embodiment having three sensor sets each comprising a single hexagonal sensor. And FIG. 22 is a schematic view of a gapless mosaiced image produced from 12 portions of a target region respectively imaged by an eleventh illustrative embodiment having three sensor sets each comprising four non-contiguous hexagonal sensors.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

We claim:

1. A digital imaging system comprising:
at least two optic modules having respective optical axes parallel to and offset from each other; and
for each of said optic modules respectively a corresponding set of at least one digital image sensor(s), each sensor spatially arranged relative to the optical axis of the corresponding optic module to image a portion of a target region that is substantially different from other portions of the target region imaged by the other sensor(s) of the system, so that all of said imaged portions together produce a seamless mosaic image of the target region.

2. The digital imaging system of claim 1,
wherein at least one of the sensor sets comprise at least two sensors non-contiguously arranged relative to each other so that the respective portions imaged thereby are separated by image gaps which are filled by the other portions of the target region imaged by the other sensor set(s) of the system.

3. The digital imaging system of claim 2,
wherein each sensor is spatially arranged relative to the optical axis of the corresponding optic module so that the portion of the target region imaged thereby partially overlaps adjacent portions of the target region imaged by the other sensor set(s) of the system.

4. The digital imaging system of claim 3,
wherein said digital image sensors are rectangular in shape.

5. The digital imaging system of claim 4,
wherein for each sensor set having at least two non-contiguous rectangular sensors, the non-contiguous rectangular sensors are aligned to form a matrixed array having rows and columns.

6. The digital imaging system of claim 5,
wherein said digital imaging system comprises at least four optic modules, and for each of said four optic modules respectively the corresponding sensor set comprises at least four rectangular sensors aligned to form a matrixed array having at least two rows and at least two columns.

7. The digital imaging system of claim 1,
wherein each sensor is spatially arranged relative to the optical axis of the corresponding optic module so that the portion of the target region imaged thereby partially overlaps adjacent portions of the target region imaged by the other sensor set(s) of the system.

8. The digital camera system of claim 1,
wherein the digital image sensors of each set are selected from the group consisting of visible, IR, UV, microwave, x-ray, photon, image intensified night vision, and radar imaging digital image sensors.

9. A digital imaging system comprising:
at least four coplanar optic modules having respective optical axes parallel to and offset from each other; and
for each of said optic modules respectively a corresponding set of at least four rectangular pixellated image sensors selected from a group consisting of visible, IR, UV, microwave, x-ray, photon, image intensified night vision, and radar imaging digital image sensors and arranged in a matrixed array having at least two rows and at least two columns, each sensor non-contiguously arranged relative to the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together produce a seamless mosaic image of the target region.

10. A digital imaging system comprising:
at least two cameras, each camera comprising:
a lens having an optical axis parallel to and offset from the optical axes of the other camera lens(es) so that an image circle thereof does not overlap with other image circle(s) of the other camera(s); and
a digital image sensor array having at least two digital image sensors each non-contiguously arranged relative to each other to digitally capture a portion of a target region which is substantially different from other portions of the target region digitally captured by the other sensors in the system but which partially overlaps with adjacent portions of the target region so that all of said portions together optically produce a gapless mosaic image of said target region.

11. The digital imaging system of claim 10,
wherein the digital image system comprises at least four cameras, with each camera having at least four rectangular digital image sensors arranged in a matrixed array with at least two rows and at least two columns.

12. A multi-camera alignment method for producing gapless mosaiced images comprising:
aligning at least two optic modules coplanar to and laterally offset from each other so that respective optical axes thereof are parallel to each other; and
for each of said optic modules respectively, spatially arranging on a common focal plane a corresponding set of at least one pixelated digital image sensor(s) relative to the optical axis of the corresponding optic module to image a portion of a target region that is substantially different from other portions of the target region imaged by the other sensor(s) of the system so that all of said portions together produce a seamless mosaic image of the target region.

13. The multi-camera alignment method of claim 12,
wherein at least one of the sensor sets comprise at least two sensors, and the spatially arranging step includes non-contiguously arranging said at least two non-contiguous sensors relative to each other so that the respective portions imaged thereby are separated by image gaps which are filled by the other portions of the target region imaged by the other sensor set(s) of the system.

14. The multi-camera alignment method of claim 13,
wherein the spatially arranging step includes spatially arranging each sensor relative to the optical axis of the corresponding optic module so that the portion of the target region imaged thereby partially overlaps adjacent portions of the target region imaged by the other sensor set(s) of the system.

15. The multi-camera alignment method of claim 14,
wherein said digital image sensors are rectangular in shape.

16. The multi-camera alignment method of claim 15,
wherein for each sensor set having at least two non-contiguous rectangular sensors, the spatially arranging step includes aligning said non-contiguous rectangular sensors to form a matrixed array having rows and columns.

17. The multi-camera alignment method of claim 16,
wherein the optic module aligning step includes aligning at least four optic modules, and for each of said four optic modules respectively the spatially arranging step includes aligning at least four rectangular sensors to form a matrixed array having at least two rows and at least two columns.

18. The multi-camera alignment method of claim 12,
wherein the step of spatially arranging includes spatially arranging each sensor relative to the optical axis of the corresponding optic module so that the portion of the target region imaged thereby partially overlaps adjacent portions of the target region imaged by the other sensor set(s) of the system.

19. The multi-camera alignment method of claim 16,
wherein the digital image sensors of each set are selected from the group consisting of visible, IR, UV, microwave, x-ray, photon, image intensified night vision, and radar imaging digital image sensors.

20. A multi-camera alignment method for producing gapless mosaiced images comprising:
aligning at least four optic modules coplanar to and laterally offset from each other so that respective optical axes thereof are parallel to each other; and
for each of said optic modules respectively, spatially arranging a corresponding set of at least four rectangular pixellated image sensors selected from a group consisting of visible, IR, UV, microwave, x-ray, photon, image intensified night vision, and radar imaging digital image sensors in a matrixed array having at least two rows and at least two columns, so that each sensor is spaced from the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together produce a seamless mosaic image of the target region.

21. A digital imaging method comprising:
providing at least two optic modules having respective optical axes parallel to and offset from each other, and for each of said optic modules respectively a corresponding set of at least one digital image sensor(s), each sensor spatially arranged relative to the optical axis of the corresponding optic module to image a portion of a target region that is substantially different from other portions of the target region imaged by the other sensor(s) of the system so that all of the portions together image all of the target region without gaps therein;
shuttering the at least two optic modules to digitally capture image data of all the portions of the target region on said sensors; and
processing the digitally captured image data to mosaic all the imaged portions of the target region into a seamless mosaic image thereof.

22. A digital imaging method comprising:
providing at least four coplanar optic modules having respective optical axes parallel to and offset from each other, and for each of said optic modules respectively a corresponding set of at least four rectangular pixellated image sensors selected from the group consisting of visible, IR, UV, microwave, x-ray, photon, image intensified night vision, and radar imaging digital image sensors and arranged in a matrixed array having at least two rows and at least two columns, each sensor non-contiguously arranged relative to the other sensors in the respective set and coplanar with all other sensors of the system to image a portion of a target region that is substantially different from other portions of the target region simultaneously imaged by the other image sensors of the system but which partially overlaps with adjacent portions of the target region, so that all of said portions together image all of the target region without gaps;
simultaneously shuttering the at least four coplanar optic modules to digitally capture image data of all the portions of the target region on said sensors; and
processing the digitally captured image data to mosaic all the imaged portions of the target region into a seamless mosaic image thereof.
